(19) United States
(12) Patent Application Publication
(10) Pub. No.: US 2015/0131305 A1
(43) Pub. Date: May 14, 2015

(54) PRIMARY OPTICAL ELEMENT, LIGHTING MODULE AND HEADLAMP FOR A MOTOR VEHICLE

(71) Applicant: Valeo Vision, Bobigny Cedex (FR)

(72) Inventors: Marine Courcier, Paris (FR); Delphine Puech, Courbevoie (FR)

(21) Appl. No.: 14/534,836

(22) Filed: Nov. 6, 2014

(30) Foreign Application Priority Data
Nov. 7, 2013 (FR) 1360920

(51) Int. Cl. F21S 8/10

(52) U.S. Cl. CPC F21S 48/1225; F21S 48/125; F21S 48/115
USPC 362/516; 362/522

(57) ABSTRACT

A primary optical element for a motor vehicle lighting module, comprising a single monoblock input member and a corrective part, the input member having at least one input face intended to receive light, the input member being connected at output to the corrective part. The corrective part comprises a light output face, at least partly in the shape of a substantially spherical dome, the input member and the corrective part forming a monoblock structure, wherein a vertical profile of the input face of the input member has a convex first part and a second part that is planar or concave.

### CROSS-REFERENCE TO RELATED APPLICATIONS

This application claims priority to French Application No. 1360920 filed Nov. 7, 2013, which application is incorporated herein by reference and made a part hereof.

### BACKGROUND OF THE INVENTION

1. Field of the Invention

The technical field of the invention is that of lighting modules for motor vehicles.

2. Description of the Related Art

A motor vehicle is fitted with headlamps or headlights which are intended to illuminate the road ahead of the vehicle, by night or in low light levels. These headlamps can generally be used in two lighting modes: a first, “high beam” mode and a second “low beam” mode. The “high beam” mode illuminates the road brightly far ahead of the vehicle. The “low beam” mode provides lighting of the road which is more limited, but still offers good visibility, without dazzling other road users. These two lighting modes complement one another. The driver of the vehicle has to change mode manually according to circumstances, with the risk of inadvertently dazzling another road user. In practice, the fact of changing lighting mode manually may lack reliability and sometimes prove dangerous. Furthermore, the low beam mode provides visibility that is sometimes unsatisfactory for the driver of the vehicle.

In order to improve the situation, headlamps provided with an ADB beam (Adaptive Driving Beam) function have been proposed. Such an ADB function is intended to automatically detect a road user likely to be dazzled by a lighting beam emitted by a headlamp in high beam mode and to modify the outline of this lighting beam so as to create a zone of shadow at the location in which the detected user is situated. The advantages of the ADB function are many: comfort of use, better visibility compared with illumination in low beam mode, better mode-change reliability, greatly reduced risk of dazzling, safer driving.

In order to perform such an ADB function there is known, for example, a system comprising a plurality of light sources, a primary optical element and an associated projection optical element, in which system the primary optical element comprises a plurality of light guides and the light guides are connected at output to a corrective part comprising an output face, the light guides and the corrective part forming a monoblock structure and the outputs from the guides of the primary optical element being positioned in an objective focal plane of the projection optical element.

The light emitted by each light source enters the associated light guide, travels as far as an output zone of the guide to emerge in the corrective part and is then emitted via the output face of the corrective part toward the associated secondary optical element. The light emitted by each optical guide output zone and projected by the secondary optical element forms a vertical light segment ahead of the vehicle. The light sources can be switched on independently of one another selectively in order to obtain the desired lighting.

Such a lighting system does, however, suffer from a number of drawbacks.

First, such a system, because of the use of several light guides which have to be spaced apart, does not allow the creation of light segments that are positioned very close together, or even contiguous with one another, in a horizontal direction.

Second, the production of the primary optical element of such a system is difficult to perform on an industrial scale because of the presence of the plurality of guides which entails the use of complex and expensive production methods in order to form these guides.

Finally, it is also important for each vertical light segment to illuminate the road brightly on one vertical side and to have a significant spread on the other vertical side so as to improve visibility for the driver of the vehicle.

### SUMMARY OF THE INVENTION

It is an object of the present invention to address these problems.

Therefore one subject of the invention is a primary optical element for a motor vehicle lighting module, comprising a single monoblock input member and a corrective part, the input member having at least one input face intended to receive light, the input member being connected at output to the corrective part, the corrective part comprising a light output face, at least partly in the shape of a substantially spherical dome, the input member and the corrective part forming a monoblock structure, wherein a vertical profile of the input face of the input member has, notably over its whole surface, a convex first part and a second part that is planar or concave.

A “vertical profile of the input face” means the profile of the input face in a cross section of this input face by a vertical plane containing an optical axis of the primary optical element when the primary topical element is in normal use, for example when the lighting module is mounted in the motor vehicle.

Thus, by virtue of the invention, it is possible to use light sources or to create at the output region of the input member secondary light sources which are arranged sufficiently close together as to be able to form almost continuous vertical segments of light.

In addition, the presence of a single monoblock input member means that industrial scale production of such a primary optical element becomes easier.

Thus, the convex first part of the vertical profile of the input face is configured so that when a light source is placed facing this input face in order to form a vertical light segment, rays of light emitted by this source enter the primary optical element via the convex first part, leave the primary optical element via the output face of the corrective part and are concentrated on one side of the vertical light segment. The concave or planar second part is configured so that other rays of light emitted by this source enter the primary optical element via the planar or concave second part, leave the primary optical element via the output face of the corrective part and are thus spread toward the other side of the vertical light segment.

Furthermore, on leaving the corrective part, thanks to the substantially spherical dome shape of the output face of this corrective part, the rays of light are deflected little, if at all.

Thus, the vertical distribution of the vertical light segment is such that the light is highly concentrated on one side of the segment and spread toward the other side of the segment.

It will be noted that the expression “the input member being connected at output to the corrective part” means that the input member is arranged so that the light received by the input member emerges into the corrective part at an output zone of the input member, this output zone being arranged at the junction between the input member and the corrective part. This output zone may be planar or curved.

It will also be noted that “substantially spherical dome” is intended to denote a surface the shape of which at least partially follows that of a sphere. In other words, the corrective part is delimited at least by an output face having at least one spherical portion.

Advantageously, the respective refractive indices of the input member and of the corrective part are substantially identical.

Refractive indices that are “substantially identical” means indices that are equal to within one hundredth. In this way, the rays undergo no refraction or practically no refraction at the output zone of the input member.

For example, the input member and the corrective part may be manufactured from the same material. If appropriate, the input member and the corrective part are produced from the same polymer, for example a polymethyl methacrylate.

For preference, the substantially spherical dome-shaped output face is centered substantially at the output zone of the input member, notably at the center of this output zone.

If desired, the corrective part may be substantially in the shape of a hemisphere.

In a first embodiment of the invention, the input face has, notably over the entirety of the surface thereof, a rectilinear horizontal profile.

The expression “horizontal profile of the input face” means the profile of the input face in a section of this input face on a plane perpendicular to the optical axis of the primary optical element when the primary optical element is in normal use, for example when the lighting module is mounted in the motor vehicle.

Advantageously, the input member has a cylindrical shape having a generatrix and a directrix. In other words, the input member has a shape obtained by a translation of the generatrix along the directrix.

For preference, with the primary optical element having an optical axis, the directrix is a straight line segment perpendicular to the optical axis. In that case, the directrix corresponds to the horizontal profile of the input face.

Advantageously, the input member has a reflection upper face having a convex vertical profile. For example, the upper face may comprise a portion of an ellipse. The upper face extends from the input face, notably from the convex first part of the input face, as far as the corrective part.

This reflection upper face of convex vertical profile is configured so that the rays of light emitted by the source, entering the input member and reaching this upper face are reflected, by total internal reflection, by this upper face toward the output face and contribute toward concentrating the light on one side of the segment.

Advantageously, the input member has a planar spreading lower face. The lower face extends from the input face, notably from the concave or planar part of the input face, as far as the corrective part.

This planar lower spreading face is configured in such a way as to widen the vertical section of the input member from the input face thereof as far as the output zone. This widening of the input member contributes to the spreading of the light on the other side of the segment.

For preference, the upper and lower faces are arranged contiguously on either side of the input face. The generatrix of the input member is thus formed by the convex profile of the upper face, the profile of the input face and the planar profile of the lower face.

If desired, the input member has two lateral faces extending between lateral edges of the upper and lower faces and from the input face as far as the corrective part.

In a second embodiment of the invention, the input face has, notably over its entire surface, a wavy horizontal profile.

If appropriate, the horizontal profile of the input face may have, notably over its entire length, a succession of convex portions each one contiguous with the next.

Each convex portion is arranged so that when a source of light is positioned facing a convex portion and a ray emitted by this light source reaches another, adjacent, convex portion, the adjacent convex portion refracts this ray toward the output face of the corrective part in a given direction so that this ray is not emitted by the lighting module.

If appropriate, the convex portions of the horizontal profile may have the same profile, notably a spherical profile.

Advantageously, the input member has a planar upper face. In that case, the upper face extends from the input face, notably from the convex part of the input face, as far as the corrective part.

If desired, the concave or planar part of the input face extends as far as the corrective part.

Another subject of the invention is a motor vehicle lighting module, notably for lighting the road, comprising a plurality of light sources, for example four light sources, a primary optical element according to the invention able to receive the rays of light emitted by the light sources and a secondary optical element, the secondary optical element being arranged to receive rays of light emerging from the output face of the corrective part of the primary optical element and to project these rays in the region of the road ahead of the lighting module.

The secondary optical element is preferably distinct from the primary optical element, notably positioned some distance in front of the primary optical element along the optical axis of the primary optical element.

Advantageously, the secondary optical element is a headlamp lens.

If desired, the headlamp lens has a front face and a rear face and comprises defusing elements, for example torroids, on its front face and/or its rear face.

As an alternative, the secondary optical element may be a reflector.

As a further alternative, the secondary optical element may be a projection system comprising a plurality of lenses and/or of reflectors.

For preference, each source is a light-emitting semiconductor element.

If appropriate, all the sources may be positioned as a single row of sources, notably in the form of a multichip LED, each source being operable to emit rays of light independently of the other sources. In that case, each chip of the multichip LED thus forms a light source, all the sources being positioned very close together. For example, the distance between two adjacent sources may be less than 0.5 mm.

According to one embodiment of the lighting module according to the invention, the primary optical element being an element according to the first embodiment described hereinabove, the secondary optical element has a horizontal focusing surface and a vertical focusing surface.

A horizontal focusing surface means a surface defined by a collection of points which are such that all the rays emitted by a source positioned at one of these points are directed by the secondary optical element in such a way that they emerge from the lighting module parallel to one another in a plane containing a horizontal line perpendicular to the optical axis of the secondary optical element.

A vertical focusing surface means a surface defined by a collection of points such that all the rays emitted by a source located at one of these points are directed by the secondary optical element in such a way that they emerge from the lighting module parallel to one another in a plane containing a vertical straight line perpendicular to the optical axis of the secondary optical element.

For preference, the optical axis of the secondary optical element coincides with the optical axis of the primary optical element.

Advantageously, the horizontal focusing surface of the secondary optical element passes through all the emission surfaces of the light sources. If appropriate, the emission surfaces of the light sources may be arranged on a horizontal straight line perpendicular to the optical axis of the secondary optical element. Thus, for each light source, the rays emitted by a point of this source, arranged on the horizontal straight line, pass through the primary optical element and are projected by the secondary optical element parallel to the optical axis. As a result, the horizontal width of the light segment formed by this light source is connected directly, notably is proportional, to the width of the source, making it possible to create a light segment of particularly narrow width. For example, the secondary optic may have a magnification, the width of the light segment being equal to the width of the light source multiplied by this magnification.

Advantageously, the output zone of the input member coincides with the vertical focusing surface of the secondary optical element. In this way, the input member creates on the output zone secondary sources the vertical distribution of which is such that the light is very highly concentrated on one side of this source and is spread toward the other side of this source. The rays from each secondary source are then projected by the secondary optical element, parallel to one another in a vertical plane, making it possible to create a light segment having this same vertical distribution.

According to another embodiment of the lighting module according to the invention, the primary optical element being in accordance with the second embodiment described hereinabove, the secondary optical element has a single focusing surface.

If appropriate, the output zone of the input member coincides with the focusing surface of the secondary optical element.

In this way, the input member creates on the output zone secondary sources the vertical distribution of which is such that the light is very highly concentrated on one side of this source and spread out toward the other side of this source. The rays of each secondary source are then projected by the secondary optical element, parallel to one another in a vertical plane, making it possible to create a light segment having this same vertical distribution.

Moreover, with the horizontal profile of the input face having, notably along the entire length thereof, a succession of convex portions contiguous one with the next, the light sources are positioned facing each convex portion.

Thus, when a light source is arranged facing a convex portion and a ray emitted by this light source reaches another adjacent convex portion, the adjacent convex portion refracts this ray toward the output face of the corrective part in a given direction, so that this ray is directed out of the secondary optical element. As a result, the width of the light segment formed by a light source is directly connected, notably proportional, to the width of the convex portion in front of which the light source is placed.

For example, the secondary optic may have a magnification, the width of the light segment being equal to the width of the convex portion multiplied by this magnification.

The invention also relates to a motor vehicle headlamp, wherein it comprises at least one lighting module as previously defined, notably several lighting modules.

These and other objects and advantages of the invention will be apparent from the following description, the accompanying drawings and the appended claims.

### BRIEF DESCRIPTION OF THE ACCOMPANYING DRAWINGS

Various embodiments of the invention will now be described with reference to the attached drawings in which:

FIG. 1 depicts a perspective view of a lighting module according to one embodiment of the invention;

FIG. 2 depicts a lateral view of the module of FIG. 1;

FIG. 3 depicts a view from above of the module of FIG. 1;

FIG. 4 depicts a perspective view of a lighting module according to another embodiment of the invention;

FIG. 5 depicts a lateral view of the module of FIG. 1; and

FIG. 6 depicts a view from above of the module of FIG. 11.

### DETAILED DESCRIPTION OF THE PREFERRED EMBODIMENTS

It will be noted henceforth that, for the sake of clarity, corresponding elements depicted in various figures bear the same references unless otherwise stated.

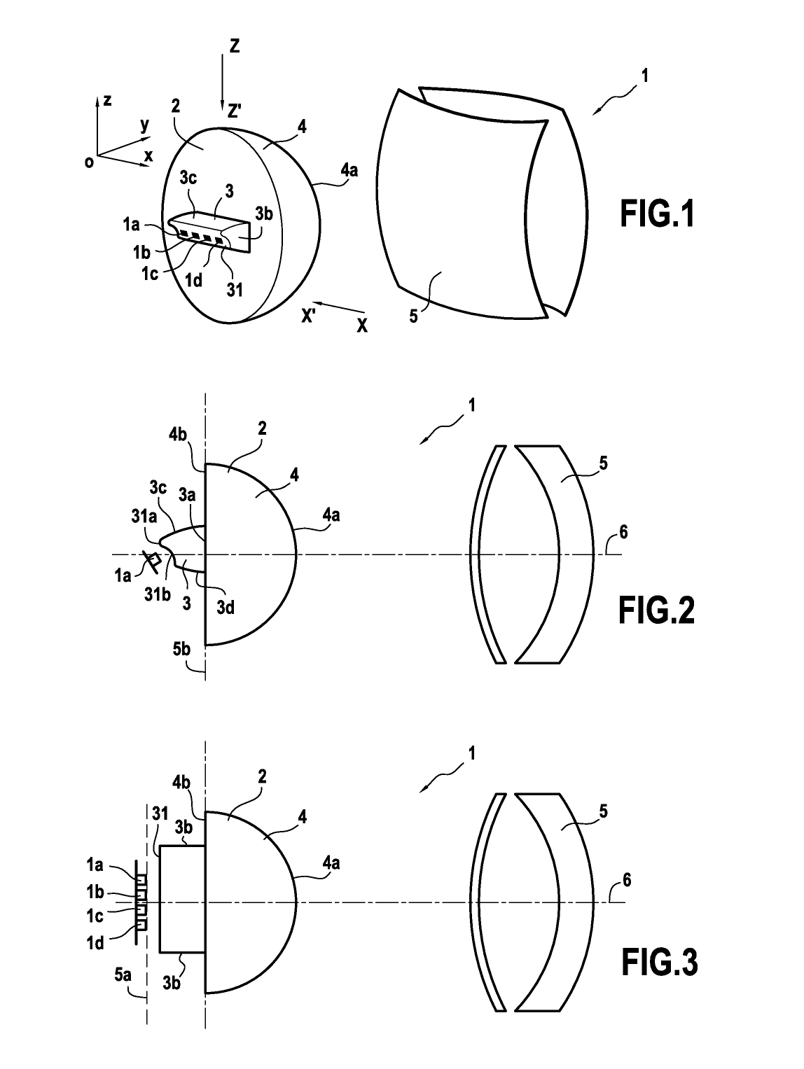

An orthogonal three-dimensional frame of reference has also been depicted in FIG. 1, the z-axis corresponding to the vertical.

FIGS. 1 to 3 depict a lighting module 1, in an operational position, intended to be fitted to a motor vehicle headlamp according to a first embodiment. FIGS. 1, 2 and 3 respectively depict a view in perspective, a side view in the direction XX′ and a view from above in the direction ZZ′, of the lighting module 1.

The lighting module 1 comprises:
a plurality of light sources, referenced 1a-1d;
a primary optical element 2; and
a secondary optical element 5 having an optical axis 6.

Each light source 1a-1d is a light-emitting semiconductor element formed by a chip of a multichip LED. Each light source 1a-1d can be activated to emit rays of light independently of the other light sources 1a-1d.

The primary optical element 2 comprises a single monoblock light input member 3 and a corrective part 4. The input member 3 is connected at an output zone 3a to the corrective part 4, the entirety forming a monoblock structure. What is meant by a “monoblock structure” is that the elements of the structure (in this case the input member 3 and the corrective part 4) cannot be separated without destroying at least one of the elements.

The corrective part 4 is a portion of a sphere, or a portion of a ball, centered on the output zone 3a. More specifically, the corrective part 4 is half a ball the center of which is situated in the output zone 3a and on the optical axis 6. The front surface 4a of the corrective part 4, in the shape of a spherical dome or spherical portion, constitutes an output front face. The rear 4b of the corrective part 4 in this instance extends in the plane of section of the hemisphere.

The input member 3 and the corrective part 4 are manufactured from the same transparent material, for example from polymethyl methacrylate, and have the same refractive index.

The input member 3 is cylindrical in shape and comprises
a light input face 31;
an output zone 3a;
two lateral faces 3b;
an upper face 3c; and
a lower face 3d.

For the sake of clarity and in order not to overload the figures, certain references of the faces of the guide are not referenced in the figures.

The input face 31 has:
vertically, a vertical profile comprising, over the entire surface thereof, a convex first part 31a and a concave second part 31b; and
horizontally, a rectilinear horizontal profile.

The upper face 3c is a reflection upper face 3c having, over its entire surface, a convex vertical profile comprising a portion of an ellipse, extending from the input face 31 as far as the rear 4b of the corrective part 4.

The lower face 3d is a planar spreading lower face 3d extending from the input face 31 as far as the rear 4b of the corrective part 4.

The vertical profiles of the upper face 3c, input face 31 and lower face 3d thus form a generatrix of the input member 3, the input member 3 therefore being formed by a translation of this generatrix along the rectilinear profile of the input face 31.

The convex first part 31 a of the vertical profile of the input face 31 is configured so that the rays of light emitted by the light sources 1a-1d and entering the primary optical element 2 via the convex first part 31a emerge into the corrective part 4 at the output zone 3a in a vertically concentrated zone. The concave second part 31b is configured so that the rays of light emitted by these light sources 1a-1d and entering the primary optical element 2 via the concave second part 31b emerge into the corrective part 4 at the output zone 3a in a vertically spread zone. Advantageously, the optical axis 6 of the secondary optical element 5 passes through the vertically concentrated zone.

The reflection upper face 3c is configured so that rays of light emitted by the light sources 1a-1d entering this input member 3 and reaching this upper face 3c are reflected, by total internal reflection, by this upper face 3c so that they emerge in the corrective part 4 at the output zone 3a in the vertically concentrated zone.

The spreading lower face 3d is configured so as to widen the vertical cross section of the input member 3 from its input face 31 as far as the output zone 3a so that all the rays passing through the concave second part 31b emerge in the vertically spread zone without encountering any obstacle in their path.

The input member 3 has a width, measured in the direction XX′, that is sufficient that none of the rays emitted by the light sources 1a-1d encounters the lateral faces 3b.

The role of the corrective part 4, in collaboration with the input member 3, is twofold.

On the one hand, it improves the optical efficiency of the light module. The input member 3 has the effect of reducing the divergence of the rays of light emitted by the light sources 1a-1d as the rays that enter the input member 3 are bent in by the laws of refraction. Further, at the output zone 3a, the rays of light are not deflected because of the connection between the input member 3 and the corrective part 4. Thanks to that, the reduced divergence of the rays is maintained. Finally, the rays of light leaving the corrective part 4 via the output face 4a are deflected little if at all thanks to the spheroidal dome shape of the output face 4a. Specifically, because the hemispherical corrective part 4 is centered on the output zone 3a, a ray originating from this output zone 3a in the region of the optical axis 6 is normal or near-normal to the output face 4a and is therefore not deflected at the interface between the corrective part 4 and the surrounding air. A ray originating from a zone distant from the optical axis 6 is bent in toward this optical axis 6. The refraction at the interface between the corrective part 4 and the surrounding medium (air) is in some way “compensated for” by the spherical or substantially spherical shape of the output face 4a.

The corrective part 4 on the other hand makes it possible to correct for field aberrations in the optical system and thus ensure good quality imaging, as will be explained in greater depth further on.

The secondary optical element 5 is a projector lens positioned a distance in front of the primary optical element 2 along the optical axis 6.

The secondary optical element 5 has a horizontal focusing surface 5a and a vertical focusing surface 5b.

The horizontal focusing surface 5a of the secondary optical element 5 passes through all the emission surfaces of the light sources 1a-1d.

Thus, for each light source 1a-1d, the rays emitted by a point of this source pass through the primary optical element 2 and are projected by the secondary optical element 5 parallel to the optical axis 6. As a result, each light source 1a-1d is capable of forming a light segment the horizontal width of which is directly connected to the width of the light source 1a-1d, making it possible to create a light segment of rectangular overall shape and particularly narrow width.

The output zone 3a of the input member 3 coincides with the vertical focusing surface 5b of the secondary optical element 5. In this way, the input member 3 creates on the output zone 3a secondary sources the vertical distribution of which comprises the vertically concentrated and spread zones. The rays from each secondary source are then projected by the secondary optical element 5 so that they are parallel to one another in a vertical plane, making it possible to create a light segment that has a vertical distribution that is such that the light is very highly concentrated on one side of the segment and spread toward the other side of the segment.

The ball-portion-shape of the corrective part 4 improves the imaging in the field. It is thus possible to generate several light segments, with good imaging, using one and the same primary optical element 2 and from the light input member 3 positioned about the optical axis 6. The half-ball of corrective part 4, by slightly altering the orientation of the rays emitted by the output zone 3a which are offset from the optical axis 6, at the output interface 4a, has a field-correcting effect.

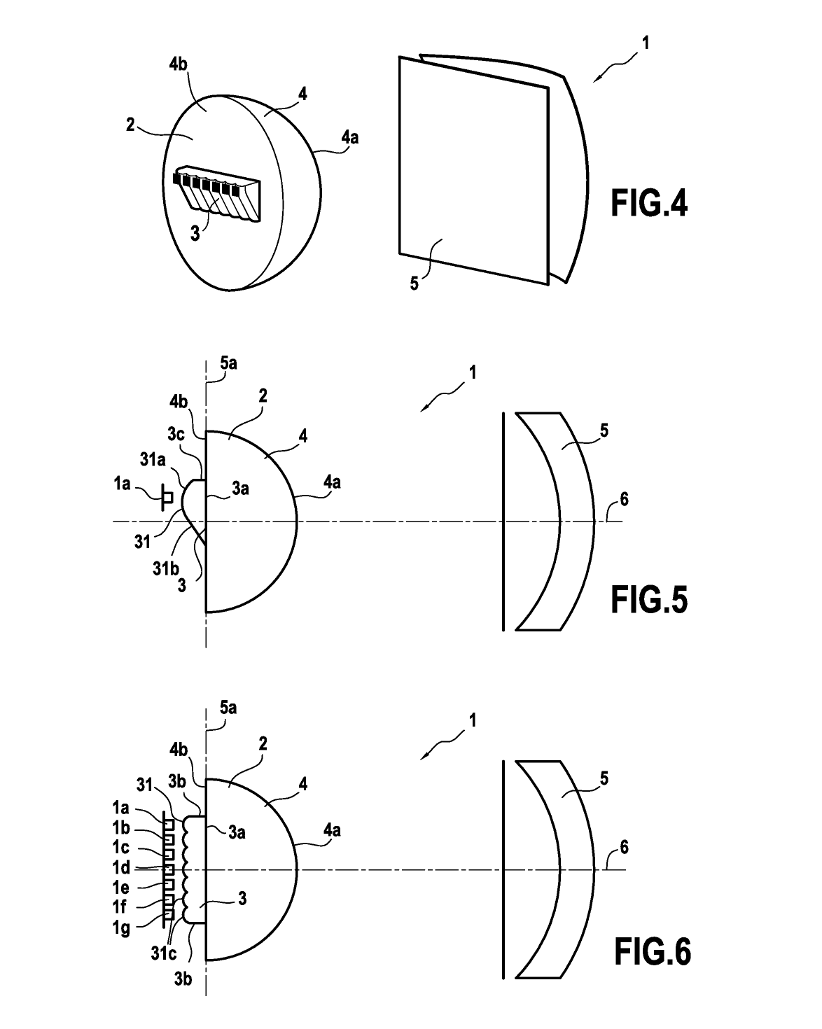

A second embodiment of the lighting module will now be described with reference to FIGS. 4 to 6. Only those elements that differ from the first embodiment are described hereinafter. FIGS. 4, 5 and 6 respectively depict a view in perspective, a lateral view in the direction XX′, and a view from above in the direction ZZ′, of the lighting module.

The lighting module 1 comprises a plurality of light sources 1a-1g depicted only in FIGS. 5 and 6.

The input member 3 comprises:
a light input face 31;
an output zone 3a;
two lateral faces 3b; and
an upper face 3c.
   For the sake of clarity and in order not to overload the figures, certain references of the input member 3 are not referenced in the figures.

The input face 31 has:
vertically, a vertical profile comprising, over its entire surface, a convex first part 31 a and a planar second part 31b; and
horizontally, a wavy horizontal profile.

The horizontal profile of the input face 31 has, over its entire length, a succession of convex portions 31c contiguous one with the next.

The convex portions 31c of the horizontal profile all have the same, notably spherical, profile.

The light sources 1a-1g are arranged facing each convex portion 31c.

The upper face 3c extends from the input face 31 to the rear part 4b of the corrective part 4.

The planar second part 31b extends as far as the rear part 4b of the corrective part 4.

The planar second part 31b is configured in such a way as to widen the vertical section of the input member 3 as far as the output zone 3a so that all the rays passing through the planar second part 31b emerge in a vertically spread zone without encountering any obstacle in their path.

Each convex portion 31c is arranged in such a way that a ray emitted by the light source 1a-1g positioned in front of this convex portion 31c reaches another, adjacent, convex portion, the adjacent convex portion refracts this ray toward the output face 4a of the corrective part 4 in a given direction, so that this ray is directed out of the secondary optical element 5. The input member 3 therefore creates, at the output zone 3a, secondary sources the width of which is directly connected to the width of the convex portions 31c and which vertically have zones of concentration and zones of spreading.

The projector lens or secondary optical element 5 has a single focusing surface 5a that coincides with the output zone 3a. The rays from each secondary source are therefore projected by the projector lens or secondary optical element 5, parallel to one another, making it possible to create a light segment of rectangular overall shape, the horizontal width of which is directly connected to the width of the convex portions 31c and that has a vertical distribution such that the light is very highly concentrated on one side of the segment and is spread toward the other side of the segment.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A primary optical element for a motor vehicle lighting module, comprising a single monoblock input member and a corrective part, said single monobock input member having at least one input face intended to receive light, said single monoblock input member being connected at output to said corrective part, said corrective part comprising a light output face, at least partly in the shape of a substantially spherical dome, said single monoblock input member and said corrective part forming a monoblock structure, wherein a vertical profile of said at least one input face of said single monoblock input member has a convex first part and a second part that is planar or concave.

2. The primary optical element according to claim 1, wherein said corrective part is substantially in the shape of a hemisphere.

3. The primary optical element according to claim 1, wherein said at least one input face has a rectilinear horizontal profile.

4. The primary optical element according to claim 1, wherein said single monoblock input member has a cylindrical shape having a generatrix and a directrix.

5. The primary optical element according to claim 3, wherein said single monoblock input member has a reflection upper face having a convex vertical profile.

6. The primary optical element according to claim 1, wherein said signal monoblock input member has a planar spreading lower face.

7. The primary optical element according to claim 1, wherein said at least one input face has a wavy horizontal profile.

8. The primary optical element according to claim 7, wherein said wavy horizontal profile of said at least one input face has a succession of convex portion each one contiguous with the next.

9. The primary optical element according to claim 8, wherein said convex portions of said wavy horizontal profile have the same profile, notably a spherical profile.

10. The primary optical element according to claim 7, wherein said signal monoblock input member has a planar upper face.

11. A motor vehicle light module comprising a plurality of light sources, said primary optical element according to claim 1 able to receive the rays of light emitted by said plurality of light sources and a secondary optical element, said secondary optical element being arranged to receive rays of light emerging from said light output face of said corrective part of said primary optical element and to project these rays in a region of a road ahead of said vehicle lighting module.

12. The motor vehicle lighting module according to claim 11, wherein said secondary optical element is a projector lens.

13. The motor vehicle lighting module according to claim 11, wherein each of said plurality of light sources is a light-emitting semiconductor element.

14. The motor vehicle lighting module according to claim 13, wherein said primary optical element being a primary optical element wherein said at least one input face has a rectilinear profile and said secondary optical element has a horizontal focusing surface and a vertical focusing surface.

15. The motor vehicle lighting module according to claim 14, wherein an output zone of said single monoblock input member coincides with said vertical focusing surface of said secondary optical element.

16. The motor vehicle lighting module according to claim 14, wherein said horizontal focusing surface of said secondary optical element passes through all the emission surfaces of said plurality of light sources.

17. The motor vehicle lighting module according to claim 11, wherein said primary optical element being a primary optical element wherein a horizontal profile of said at least one input face has a succession of convex portions and wherein said secondary optical element has a single focusing surface.

18. The motor vehicle lighting module according to claim 17, wherein an output zone of said single monoblock input member coincides with said single focusing surface of said secondary optical element.

19. A vehicle headlamp, comprising at least one lighting module according to claim 11.

20. The primary optical element according to claim 2, wherein said at least one input face has a rectilinear horizontal profile.
